(19) United States
(12) Patent Application Publication
(10) Pub. No.: US 2005/0219971 A1
(43) Pub. Date: Oct. 6, 2005

(54) METHOD AND APPARATUS FOR RECOVERING RFZC SIGNAL TO CORRECT PHASE

(76) Inventors: Bor-Cheng Shih, Kao-Hsiung Hsien (TW); Shun-Yung Wang, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/907,056

(22) Filed: Mar. 18, 2005

(30) Foreign Application Priority Data
Apr. 6, 2004 (TW) 093109504

(51) Int. Cl. G11B 7/00

(52) U.S. Cl. 369/44.28; 369/44.34

(57) ABSTRACT

A method for generating a phase-corrected radio frequency zero crossing (PKRFZC) signal includes generating a pseudo radio frequency zero crossing (PSRFZC) signal according to a track error (TE) signal of an optical storage device, and outputting the PSRFZC signal or an inverted signal of the PSRFZC signal as the PKRFZC signal according to variations of a phase difference between a track error zero crossing (TEZC) signal and an radio frequency zero crossing (RFZC) signal of the optical storage device. A value of the phase difference between the PKRFZC signal and the TEZC signal is 90 degrees. The lead or lag relationship between the PKRFZC signal and the TEZC signal follow the disc run-out during seeking.

### BACKGROUND

The present invention relates optical storage systems, and more particularly, to a method and an apparatus for recovering a RFZC signal to correct a phase of the RFZC signal while considering directional characteristics of the phase.

A Digital Versatile Disc (DVD) and a DVD drive are typical of the optical storage disc and the optical storage device, respectively. When an optical storage device reads data stored on an optical storage disc or writes data onto the optical storage disc, the optical storage device has to firstly move an optical pickup (OPU) of the optical storage device toward a track on the optical storage disc and secondly perform data accessing operation such as writing or reading data. The track crossing speed and track crossing direction of the OPU with respect to the optical storage disc are important parameters of the optical storage device while performing track crossing control. Only when the track crossing direction is correctly determined, can the optical storage device correctively control a sled motor thereof to move the OPU toward a target track on the optical storage disc and perform the data accessing operation. While performing the track crossing control, the optical storage device has to continuously confirm the track crossing direction to maintain a corresponding servo control. Typically, various ways of determining the track crossing direction are used for ranges of value of the track crossing speed, respectively. For example, when the OPU operates using a small value of the track crossing speed, the optical storage device may determine the track crossing direction of the OPU according to a value of a phase difference between a track error (TE) signal and a radio frequency ripple (RFRP) signal, wherein the TE signal is generated according to OPU location accuracy with respect to the target track, and the RFRP signal is generated according to reflected laser light from a tiny groove or a land of the optical storage disc illuminated by laser light omitted from the OPU.

In addition, a track error zero crossing (TEZC) signal generated according to the TE signal can be utilized to represent a time sequence characteristic of zero crossing of the TE signal with respect to a level. Similarly, a radio frequency zero crossing (RFZC) signal generated according to the RFRP signal can be utilized to represent a time sequence characteristic of zero crossing of the RFRP signal with respect to a level. Utilizing a characteristic that a value of a phase difference between the RFZC signal and the TEZC signal is 90 degrees and a characteristic that a phase lead or phase lag relationship between the RFZC signal and the TEZC signal is varied according to a moving direction of the OPU with respect to the optical storage disc, the optical storage device may lock onto a target track more accurately during track seeking. However, with a great diversity of specifications of various kinds of optical storage discs, most optical storage devices in the art do not have a 90 degrees value of a phase difference between the RFZC signal and the TEZC signal so that these prior art optical storage devices perform track seeking inefficiently or even incorrectly.

### SUMMARY

According to a preferred embodiment, the present invention provides a method for generating a phase-corrected radio frequency zero crossing (PKRFZC) signal. The method includes: reading a track error zero crossing (TEZC) signal of an optical storage device, wherein the TEZC signal is generated according to a track error (TE) signal of the optical storage device; reading a radio frequency zero crossing (RFZC) signal of the optical storage device, wherein the RFZC signal is generated according to a radio frequency ripple (RFRP) signal of the optical storage device; and generating a pseudo radio frequency zero crossing (PSRFZC) signal according to the TE signal, wherein a value of a phase difference between the PSRFZC signal and the TE signal is 90 degrees, and a phase lead or phase lag relationship between the PSRFZC signal and the TE signal is independent of a seek direction of an optical pickup (OPU) of the optical storage device. That is, the PSRFZC signal and the TE signal are direction independent. The method further includes detecting phases of the TEZC signal and the RFZC signal; and outputting the PSRFZC signal or an inverted signal of the PSRFZC signal according to variations of a phase difference between the TEZC signal and the RFZC signal to generate the PKRFZC signal.

Accordingly, the present invention further provides a circuit for generating a phase-corrected radio frequency zero crossing (PKRFZC) signal. The circuit includes: a phase detection unit for generating a multiplexing signal according to a track error zero crossing (TEZC) signal and a radio frequency zero crossing (RFZC) signal of an optical storage device; a pseudo radio frequency zero crossing (PSRFZC) unit for generating a PSRFZC signal according to a track error (TE) signal of the optical storage device; a first inverter electrically connected to the PSRFZC unit for generating an inverted signal of the PSRFZC signal according to the PSRFZC signal; and a first multiplexer electrically connected to the first inverter, the PSRFZC unit, and the phase detection unit for multiplexing the PSRFZC signal or the inverted signal of the PSRFZC signal according to the multiplexing signal to generate the PKRFZC signal.

### BRIEF DESCRIPTION OF DRAWINGS

FIG. 1 is a flowchart of a method for generating a phase-corrected radio frequency zero crossing (PKRFZC) signal according to the present invention.

FIG. 2 is a diagram of a circuit for generating the PKRFZC signal according to the present invention.

FIG. 3 is an operational diagram of the PSRFZC unit shown in FIG. 2.

FIG. 4 is an operational diagram of the PSRFZC unit shown in FIG. 2.

FIG. 5 is a state table of the PD signal shown in FIG. 2.

FIG. 6 is an operational diagram of the method shown in FIG. 1.

FIG. 7 is an operational diagram of the method shown in FIG. 1.

### DETAILED DESCRIPTION

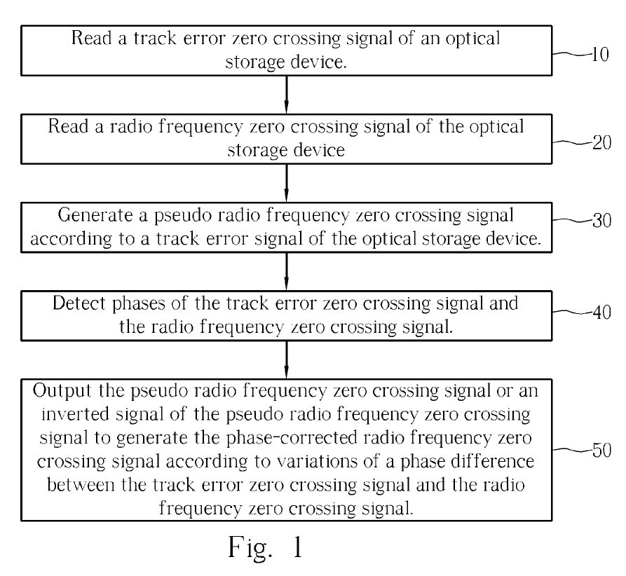

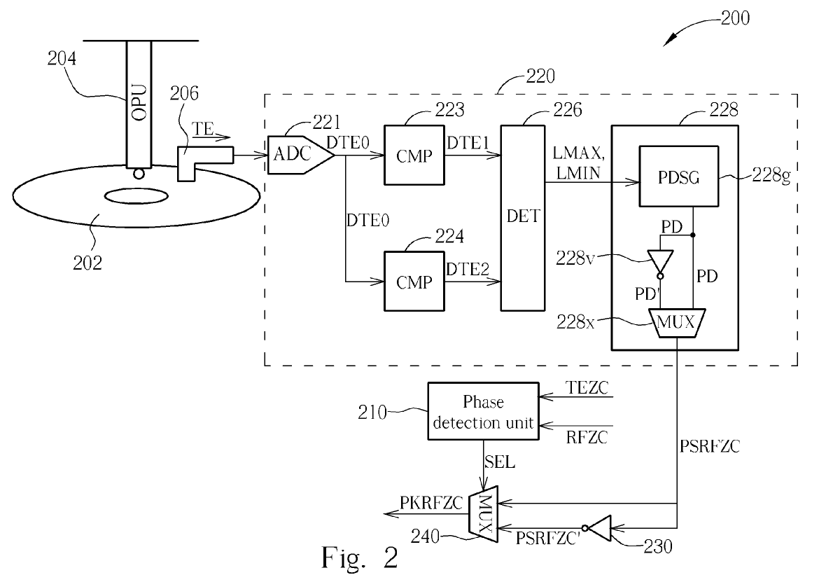

A first embodiment of the present invention provides a method for generating a phase-corrected radio frequency zero crossing (PKRFZC) signal and a circuit corresponding to the method. Please refer to both FIG. 1 and FIG. 2. FIG. 1 is a flowchart of the method for generating the PKRFZC signal according to the present invention. FIG. 2 is a diagram of a circuit 200 for generating the PKRFZC signal according to the present invention. The circuit 200 includes a phase detection unit 210, a pseudo radio frequency zero crossing (PSRFZC, i.e. pseudo RFZC) unit 220, an inverter 230 electrically connected to the PSRFZC unit 220, and a multiplexer 240 electrically connected to the inverter 230, the PSRFZC unit 220, and the phase detection unit 210. In addition, the PSRFZC unit 220 includes an analogue-to-digital converter (ADC) 221, a comparator 223 electrically connected to the ADC 221, a comparator 224 electrically connected to the ADC 221, a signal detector 226 electrically connected to the comparator 223 and the comparator 224, and a PSRFZC signal generator 228 electrically connected to the signal detector 226. In the present embodiment, the PSRFZC signal generator 228 includes a peak detection (PD) signal generator 228g electrically connected to the signal detector 226, an inverter 228v electrically connected to the PD signal generator 228g, and a multiplexer 228x electrically connected to the inverter 228v and the PD signal generator 228g.

In the first embodiment, the circuit 200 shown in FIG. 2 is installed in an optical storage device. In addition, the optical storage disc 202 is a Digital Versatile Disc (DVD) and the optical storage device is a DVD drive. Other kinds of optical storage media and optical storage devices can be applied to the present invention. Steps of the method according to this embodiment are described as follows, while the order of the steps is not a limitation of the present invention.

Step 10: Read a track error zero crossing (TEZC) signal of an optical storage device using the phase detection unit 210, wherein the TEZC signal is generated according to a track error (TE) signal of the optical storage device.

Step 20: Read a radio frequency zero crossing (RFZC) signal of the optical storage device using the phase detection unit 210, wherein the RFZC signal is generated according to a radio frequency ripple (RFRP) signal of the optical storage device.

Step 30: Generate a pseudo radio frequency zero crossing (PSRFZC) signal according to the track error (TE) signal using the PSRFZC unit 220, wherein a value of a phase difference between the PSRFZC signal and the TE signal is 90 degrees. In this embodiment, the PSRFZC signal is generated by firstly preprocessing the TE signal using the ADC 221, the comparators 223 and 224, and the signal detector 226; and secondly generating a PD signal using the PD signal generator 228g. The PSRFZC signal generator 228 is capable of instructing the multiplexer 228x to output the PD signal or an inverted signal of the PD signal according to a moving direction of an optical pickup (OPU) 204 of the optical storage device to generate the PSRFZC signal. As shown in FIG. 2, the inverted signal of the PD signal is labeled as PD′ and is generated by inverting the PD signal using the inverter 228v.

Step 40: Detect phases of the TEZC signal and the RFZC signal using the phase detection unit 210 to monitor variations of a phase difference between the TEZC signal and the RFZC signal. In the present embodiment, detection results of the phase detection unit 210 are represented using states of the multiplexing signal SEL. Please note, the states of the multiplexing signal SEL includes an inversion disabling state and an inversion enabling state. When the phases detected in this step indicate either that a phase lead state of the RFZC signal with respect to the TEZC signal is changed to a phase lag state or that a phase lag state of the RFZC signal with respect to the TEZC signal is changed to a phase lead state, the multiplexing signal SEL correspondingly changes from the inversion disabling state to the inversion enabling state.

Step 50: Output the PSRFZC signal or an inverted signal of the PSRFZC signal using the multiplexer 240 to generate the PKRFZC signal according to the variations of a phase difference between the TEZC signal and the RFZC signal to generate the PKRFZC signal. In the present embodiment, when the multiplexing signal SEL is at the inversion disabling state, the multiplexer 240 outputs the PSRFZC signal as the PKRFZC signal. Conversely, when the multiplexing signal SEL is at the inversion enabling state, the multiplexer 240 outputs the inverted signal of the PSRFZC signal as the PKRFZC signal. As shown in FIG. 2, the inverted signal of the PSRFZC signal is labeled as PSRFZC′ and is generated by inverting the PSRFZC signal using the inverter 230.

As Step 10 and step 20 are well known in the art, they will not be repeated in the following. As described in step 30, the present invention utilizes the PSRFZC unit 220 to provide the PSRFZC signal, wherein the value of the phase difference between the PSRFZC signal and the TE signal is 90 degrees. The reason that the value of the phase difference mentioned above is 90 degrees is explained as follows. When the OPU 204 moves along a radial direction of the optical storage disc 202, the TE signal generated according to detection signals of a plurality of optical sensors 206 is converted into a plurality of discrete digital signals DTE0 by the ADC 221. The comparator 223 is capable of filtering the plurality of digital signals DTE0 so that out of the plurality of digital signals DTE0, digital signals DTE1 that are greater than an upper threshold pass through the comparator 223. In addition, the comparator 224 is capable of filtering the plurality of digital signals DTE0 so that out of the plurality of digital signals DTE0, digital signals DTE2 that are less than a lower threshold pass through the comparator 224. According to this embodiment, the signal detector 226 is capable of detecting local maximums LMAX of the TE signal from the digital signals DTE1 that pass through the comparator 223. That is, the signal detector 226 is capable of calculating a plurality of local averages according to the digital signals DTE1, which pass through the comparator 223, wherein each local average of the digital signals DTE1 is an average of continuously transmitted digital signals out of the digital signals DTE1. The signal detector 226 compares the plurality of local averages to detect the local maximums LMAX of the TE signal. Similarly, the signal detector 226 is capable of detecting local minimums LMIN of the TE signal from the digital signals DTE2 that pass through the comparator 224. That is, the signal detector 226 is capable of calculating a plurality of local averages according to the digital signals DTE2, which pass through the comparator 224, wherein each local average of the digital signals DTE2 is an average of continuously transmitted digital signals out of the digital signals DTE2, and the signal detector 226 compares the plurality of local averages to detect the local minimums LMIN of the TE signal.

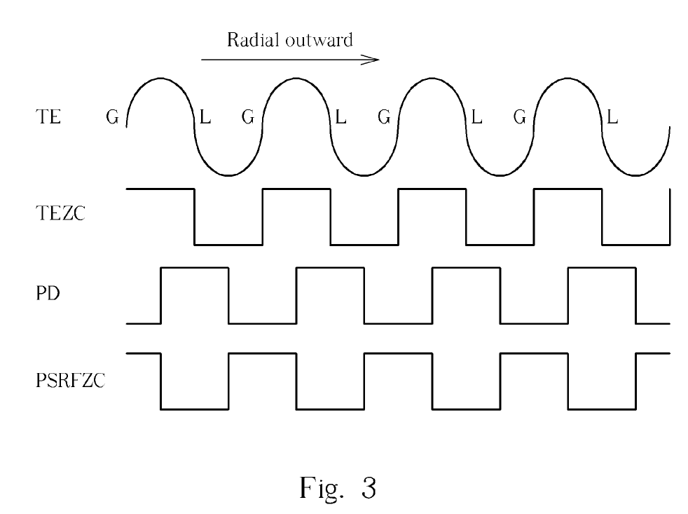

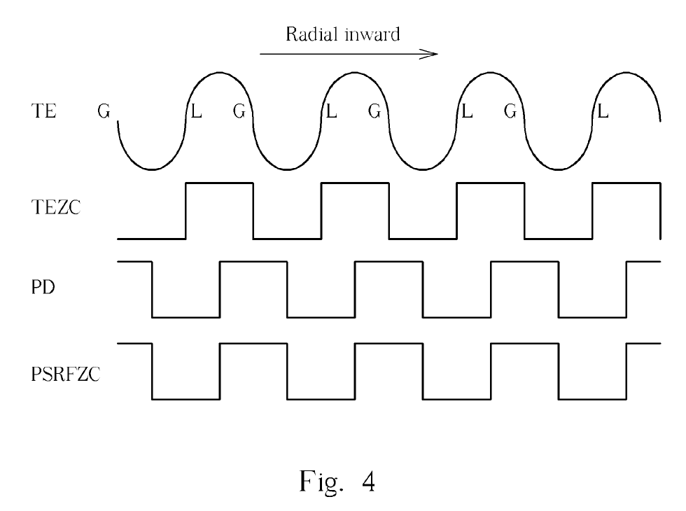

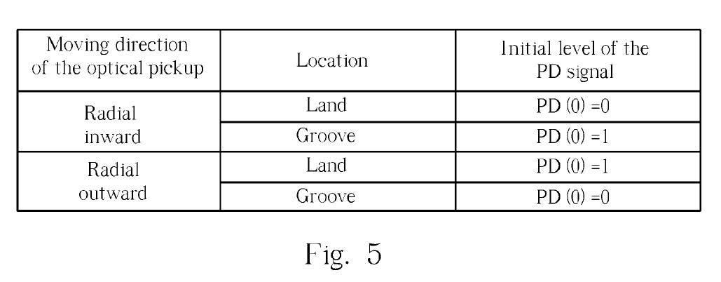

Please refer to FIG. 1 to FIG. 5. Both FIG. 3 and FIG. 4 are operational diagrams of the PSRFZC unit 220 shown in FIG. 2. FIG. 5 is a table illustrating the relationship between an initial level of the PD signal shown in FIG. 2, a location of the OPU 204, and the moving direction of the OPU 204. Along curves of the TE signal shown in FIG. 3 and FIG. 4, labels “L” denote waveforms generated while the OPU is on a land and labels “G” denote waveforms generated while the OPU is on a grove. In the second column of the table shown in FIG. 5, “Land” corresponds to the labels “L” shown in FIG. 3 and FIG. 4, and “Groove” corresponds to the labels “G” shown in FIG. 3 and FIG. 4. Please note, the PD signal generator 228g generates the PD signal according to the initial level of the PD signal illustrated in the third column of the table shown in FIG. 5. In this embodiment, the PD signal generator 228g generates the PD signal as shown in FIG. 3 and FIG. 4 according to the local maximums LMAX and the local minimums LMIN of the TE signal mentioned above. As shown in FIG. 3 and FIG. 4, when the PD signal toggles from one level to another level, an edge being either a rising edge or a falling edge is generated. The rising edge or the falling edge of the PD signal corresponds to either a location where one of the local maximums LMAX occurs or a location where one of the local minimums LMIN of the TE signal. As a result, an absolute value of a value of a phase difference between the PD signal and the TE signal is always 90 degrees. As mentioned, the inverter 228v is capable of converting the PD signal into the inverted signal PD′. Then the PSRFZC signal generator 228 may utilizes the multiplexer 228x to multiplex the PD signal or the inverted signal PD′ according to a moving direction of the OPU 204 of the optical storage device and output either the PD signal or the inverted signal PD′ to generate the PSRFZC signal so that a sign of the value of the phase difference between the PD signal and the TE signal is changed accordingly. As illustrated in FIG. 4, when the OPU 204 moves inward along a radial direction of the optical storage disc 202, the PSRFZC signal is equivalent to the PD signal. Conversely, as illustrated in FIG. 3, when the OPU 204 moves outward along a radial direction of the optical storage disc 202, the PSRFZC signal is equivalent to the inverted signal PD′.

When the RFZC signal leads the TEZC signal in phase, it is uncertain whether the PSRFZC signal generated in step 30 leads the TEZC signal in phase. In addition, when the RFZC signal lags behind the TEZC signal in phase, it is uncertain whether the PSRFZC signal generated in step 30 lags behind the TEZC signal in phase. However, by transmitting the detection results representing that the RFZC signal leads the TEZC signal in phase or that the RFZC signal lags behind the TEZC signal in phase from the phase detection unit 210 to the multiplexer 240 through the multiplexing signal SEL, the multiplexer 240 is capable of outputting the PSRFZC signal or the inverted signal PSRFZC′ according to the multiplexing signal SEL to generate the PKRFZC. As a result, when the RFZC signal leads the TEZC signal in phase, it is certain that the PKRFZC signal leads the TEZC signal in phase. In addition, when the RFZC signal lags behind the TEZC signal in phase, it is certain that the PKRFZC signal lags behind the TEZC signal in phase. In this embodiment, the multiplexer 240 controls the PKRFZC signal to be in a phase lead state with respect to the TEZC signal when the phases of the TEZC signal and the RFZC signal detected by the phase detection unit 210 indicate that the RFZC signal leads the TEZC signal. The multiplexer 240 controls the PKRFZC signal to be in a phase lag state with respect to the TEZC signal when the phases detected by the phase detection unit 210 indicate that the RFZC signal lags behind the TEZC signal. Therefore, a value of a phase difference between the PKRFZC signal and the TE signal is 90 degrees accordingly. In addition, by converting the PSRFZC signal into the PKRFZC signal using step 40 and step 50, an incorrect phase lead state of the PSRFZC signal is replaced with the correct phase lag state of the PKRFZC signal, and an incorrect phase lag state of the PSRFZC signal is replaced with the correct phase lead state of the PKRFZC signal. Since phase lead or phase lag relationship between the PKRFZC signal and the TE signal is related to a seek direction, i.e. the track crossing direction or the moving direction of the OPU 204 while the optical storage is performing track seeking, the correct phase lead state and the correct phase lag state of the PKRFZC signal can be utilized for detecting the seek direction of the OPU 204. Please note, the characteristic that the value of the phase difference between the PKRFZC signal and the TE signal is 90 degrees and the characteristics of the correct phase lead state and the correct phase lag state of the PKRFZC signal ensure that the optical storage device according to the present invention performs track seeking efficiently and correctly. According to the present invention, the track seeking success rate of the optical storage device is greatly improved in contrast to the prior art.

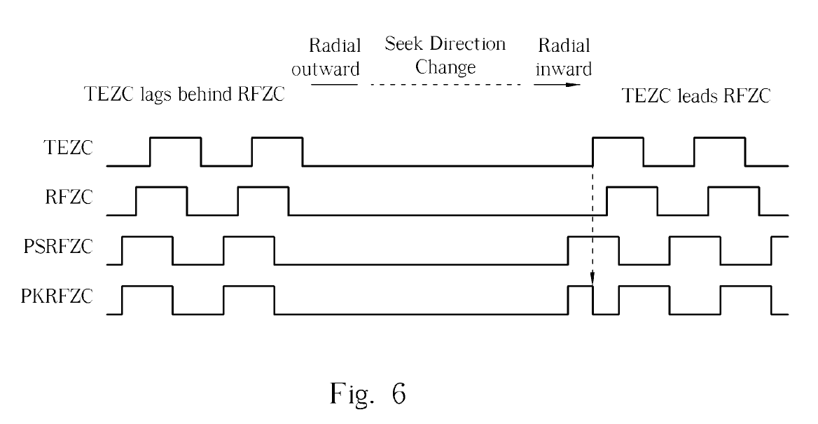

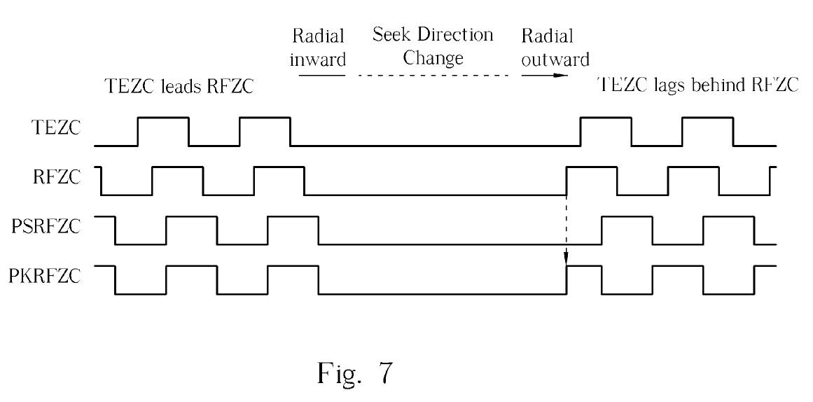

Please refer to FIG. 1, FIG. 2, FIG. 6, and FIG. 7. Both FIG. 6 and FIG. 7 are operational diagrams of the method shown in FIG. 1. When the phases of the TEZC signal and the RFZC signal detected by the phase detection unit 210 indicate either that a phase lead state of the RFZC signal with respect to the TEZC signal is changed to a phase lag state or that a phase lag state of the RFZC signal with respect to the TEZC signal is changed to a phase lead state, the phase detection unit 210 controls the multiplexing signal SEL to change from the inversion disabling state to the inversion enabling state correspondingly so that, according to step 50, the multiplexer 240 starts to output the inverted signal PSRFZC′ as the PKRFZC signal. Therefore, when the RFZC signal leads the TEZC signal in phase, it is certain that the PKRFZC signal outputted in step 50 leads the TEZC signal in phase. In addition, when the RFZC signal lags behind the TEZC signal in phase, it is certain that the PKRFZC signal outputted in step 50 lags behind the TEZC signal in phase.

Furthermore, although steps 10, 20, and 40 are described using the TEZC signal and the RFZC signal, this is not meant as a limitation of the present invention. In fact, the phase of the TEZC signal corresponds to the phase of the TE signal, and the phase of the RFZC signal corresponds to the phase of the RFRP signal. The TEZC signal generated according to the TE signal can be utilized to represent a time sequence characteristic of zero crossings of the TE signal with respect to a level. That is, inversion times and inversion directions of the TEZC signal correspond to crossing timing and crossing direction of the TE signal with respect to the level, respectively. Wherein the level can be an average level of a local maximum and a local minimum derived from the TE signal. Similarly, the RFZC signal generated according to the RFRP signal can be utilized to represent a time sequence characteristic of zero crossing of the RFRP signal with respect to a level. That is, inversion times and inversion directions of the RFZC signal correspond to crossing timing and crossing direction of the RFRP signal with respect to the level, respectively. Wherein the level can be an average level of a local maximum and a local minimum derived from the RFRP signal. By executing step 10 and step 20, step 40 is capable of detecting the phases of the TEZC signal and the RFZC signal using the phase detection unit 210. Therefore, the phases of the TE signal and the RFRP signal are also derived in step 40 accordingly, and when the phase detection unit 210 detects the phase lead state or the phase lag state of the RFZC signal with respect to the TEZC signal, the phase detection unit 210 also detects the phase lead state or the phase lag state of the RFRP signal with respect to the TE signal. A second embodiment of the present invention is similar to the first embodiment. According to the second embodiment, step 10 and step 20 read the TE signal and the RFRP signal of the optical storage device using the phase detection unit 210, respectively, and step 40 detects the phases of the TE signal and the RFRP signal using the phase detection unit 210 to monitor variations of a phase difference between the TE signal and the RFRP signal.

In contrast to the prior art, a value of a phase difference between the PKRFZC signal and the TEZC signal generated by the present invention method and device is 90 degrees. Therefore, the track seeking success rate of the optical storage device is greatly improved. In addition, according to the present invention, a phase lead state or a phase lag state of the PKRFZC signal with respect to the TEZC signal can be utilized to detect the seek direction or the track crossing direction of the OPU of the optical storage device.

1. A method for generating a phase-corrected radio frequency zero crossing (PKRFZC) signal comprising:
(a) reading a track error zero crossing (TEZC) signal of an optical storage device, wherein the TEZC signal is generated according to a track error (TE) signal of the optical storage device;
(b) reading a radio frequency zero crossing (RFZC) signal of the optical storage device, wherein the RFZC signal is generated according to a radio frequency ripple (RFRP) signal of the optical storage device;
(c) generating a pseudo radio frequency zero crossing (PSRFZC) signal according to the TE signal;
(d) detecting phases of the TEZC signal and the RFZC signal; and
(e) outputting the PSRFZC signal or an inverted signal of the PSRFZC signal according to variations of a phase difference between the TEZC signal and the RFZC signal to generate the PKRFZC signal.

2. The method of claim 1, wherein step (e) further comprises:
when the phases detected in step (d) indicate either that a phase lead state of the RFZC signal with respect to the TEZC signal has changed to a phase lag state or that a phase lag state of the RFZC signal with respect to the TEZC signal has changed to a phase lead state, starting to output the inverted signal of the PSRFZC signal to generate the PKRFZC signal.

3. The method of claim 1, wherein step (e) further comprises performing multiplexing to output the PSRFZC signal or the inverted signal of the PSRFZC signal.

4. The method of claim 3, wherein step (d) further comprises generating a detection result according to the phases of the TEZC signal and the RFZC signal, and step (e) further comprises performing the multiplexing according to the detection result to output the PSRFZC signal or the inverted signal of the PSRFZC signal.

5. The method of claim 1, wherein step (c) further comprises:
converting the TEZC signal into a plurality of digital signals;
filtering the plurality of digital signals so that digital signals out of the plurality of digital signals being greater than a first threshold pass through;
filtering the plurality of digital signals so that digital signals out of the plurality of digital signals being less than a second threshold pass through;
detecting local maximums and local minimums of the TE signal out of the digital signals that pass through;
generating a peak detection (PD) signal according to the local maximums and the local minimums of the TE signal; and
when an optical pickup (OPU) of the optical storage device moves inward along a radial direction of an optical storage disc, outputting the PD signal to generate the PSRFZC signal, and when the OPU moves outward along a radial direction of the optical storage disc, outputting an inverted signal of the PD signal to generate the PSRFZC signal.

6. The method of claim 1, wherein step (e) further comprises controlling the PKRFZC signal to be in a phase lead state with respect to the TEZC signal when the phases detected in step (d) indicate that the RFZC signal leads the TEZC signal, and controlling the PKRFZC signal to be in a phase lag state with respect to the TEZC signal when the phases detected in step (d) indicate that the RFZC signal lags behind the TEZC signal, wherein a value of a phase difference between the PKRFZC signal and the TEZC signal is 90 degrees.

7. The method of claim 1, wherein step (c) further comprises generating the PSRFZC signal by inverting the PSRFZC signal from a first level to a second level when a local maximum of the TE signal occurs and inverting the PSRFZC signal from the second level to the first level when a local minimum of the TE signal occurs.

8. The method of claim 1, wherein step (c) further comprises generating the PSRFZC signal by firstly generating a peak detection (PD) signal according to the TE signal, and secondly outputting the PD signal or an inverted signal of the PD signal according to a moving direction of an optical pickup (OPU) of the optical storage device to generate the PSRFZC signal.

9. The method of claim 8, wherein step (c) further comprises generating the PSRFZC signal by outputting the PD signal when the OPU moves inward along a radial direction of an optical storage disc and outputting the inverted signal of the PD signal when the OPU moves outward along a radial direction of the optical storage disc.

10. The method of claim 1, wherein the optical storage device is a Digital Versatile Disc (DVD) drive.

11. A circuit for generating a phase-corrected radio frequency zero crossing (PKRFZC) signal, the circuit comprising:
a phase detection unit for generating a multiplexing signal according to a track error zero crossing (TEZC) signal and a radio frequency zero crossing (RFZC) signal of an optical storage device;
a pseudo radio frequency zero crossing (PSRFZC) unit for generating a PSRFZC signal according to a track error (TE) signal of the optical storage device;
a first inverter electrically connected to the PSRFZC unit for generating an inverted signal of the PSRFZC signal according to the PSRFZC signal; and
a first multiplexer electrically connected to the first inverter, the PSRFZC unit, and the phase detection unit for multiplexing the PSRFZC signal or the inverted signal of the PSRFZC signal according to the multiplexing signal to generate the PKRFZC signal.

12. The circuit of claim 11, wherein the first multiplexer outputs the PSRFZC signal when the multiplexing signal is in a first state, and the first multiplexer outputs the inverted signal of the PSRFZC signal when the multiplexing signal is in a second state.

13. The circuit of claim 12, wherein when phases of the TEZC signal and the RFZC signal detected by the phase detection unit indicate either that a phase lead state of the RFZC signal with respect to the TEZC signal has changed to a phase lag state or that a phase lag state of the RFZC signal with respect to the TEZC signal has changed to a phase lead state, the phase detection unit controls the multiplexing signal to change from the first state to the second state correspondingly so that the multiplexer starts to output the inverted signal of the PSRFZC signal to generate the PKRFZC signal.

14. The circuit of claim 11, wherein the multiplexer controls the PKRFZC signal to be in a phase lead state with respect to the TEZC signal when phases of the TEZC signal and the RFZC signal detected by the phase detection unit indicate that the RFZC signal leads the TEZC signal, the multiplexer controls the PKRFZC signal to be in a phase lag state with respect to the TEZC signal when the phases detected by the phase detection unit indicate that the RFZC signal lags behind the TEZC signal, and a value of a phase difference between the PKRFZC signal and the TEZC signal is 90 degrees.

15. The circuit of claim 11, wherein the PSRFZC unit further comprises:
an analogue-to-digital converter (ADC) for converting the TE signal into a plurality of digital signals;
a first comparator electrically connected to the ADC for filtering the plurality of digital signals so that digital signals out of the plurality of digital signals being greater than a first threshold pass through;
a second comparator electrically connected to the ADC for filtering the plurality of digital signals so that digital signals out of the plurality of digital signals being less than a second threshold pass through;
a signal detector electrically connected to the first comparator and the second comparator for detecting local maximums and local minimums of the TE signal out of the digital signals that pass through one of the first comparator and the second comparator; and
a PSRFZC signal generator electrically connected to the signal detector for generating a peak detection (PD) signal according to the local maximums and the local minimums of the TE signal and outputting the PD signal or an inverted signal of the PD signal to generate the PSRFZC signal.

16. The circuit of claim 15, wherein the PSRFZC signal generator further comprises:
a PD signal generator electrically connected to the signal detector for generating the PD signal according to the local maximums and the local minimums of the TE signal;
a second inverter electrically connected to the PD signal generator for generating the inverted signal of the PD signal according to the PD signal; and
a second multiplexer electrically connected to the second inverter and the PD signal generator for outputting the PD signal or the inverted signal of the PD signal according to a moving direction of an optical pickup (OPU) of the optical storage device to generate the PSRFZC signal.

17. The circuit of claim 16, wherein when the OPU moves inward along a radial direction of an optical storage disc, the second multiplexer outputs the PD signal, and when the OPU moves outward along a radial direction of the optical storage disc, the second multiplexer outputs the inverted signal of the PD signal.

18. The circuit of claim 11, wherein the optical storage device is a Digital Versatile Disc (DVD) drive.
